(19) United States
(12) Patent Application Publication
(10) Pub. No.: US 2014/0280586 A1
(43) Pub. Date: Sep. 18, 2014

(54) Method and Devices to Reduce Presence Server Traffic

(71) Applicant: Infinite Convergence Solutions, Inc., Arlington Heights, IL (US)

(72) Inventors: Thomas C Hoffman, Arlington Heights, IL (US); Thomas B Hart, West Dundee, IL (US)

(21) Appl. No.: 14/199,914

(22) Filed: Mar. 6, 2014

Related U.S. Application Data
(60) Provisional application No. 61/777,867, filed on Mar. 12, 2013.

(51) Int. Cl. H04L 12/801

(52) U.S. Cl. CPC H04L 47/10
USPC 709/204

(57) ABSTRACT

This is a new method to reduce traffic to a presence server as well as modified client and server devices which send and receive messages to support that new method.

### CROSS-REFERENCE TO RELATED APPLICATIONS

This application claims the benefit of US provisional application 61/777,867 filed on Mar. 12, 2013 by the present inventors which is incorporated by reference into this application.

### FEDERALLY SPONSORED RESEARCH

None.

### SEQUENCE LISTING

None.

### FIELD OF THE INVENTION

This relates to communication clients and infrastructure including Instant message and Rich Communication clients as well as to presence server infrastructure devices.

### BACKGROUND OF THE INVENTION

A presence server typically provides telecommunications and internet applications with real-time information regarding a users availability, capability and willingness to communicate. For example, users may have their user equipment (UE) available and ready to communicate or they may busy but available for emergencie, they may have a “do not disturb” indicator, or they may have their equipment powered off. The presence server would typically share the presence information of one client with other “watchers” that have subscribed to get their status updates, such as with a “buddy list.” Sharing of presence information typically involves many messages sent between User Equipment (UE) and the Presence Server to keep the UE's presence status up-to-date in real time to other UE's or applications which may be watching the status of this UE. The amount of messaging traffic presents a capacity challenge to modern telecommunications networks. In the current art, using the Session Initiation Protocol (SIP) known in the industry, every time there is a chance in the status of a UE, all subscribers watching that UE will receive a SIP NOTIFY with the new status of the UE. These SIP NOTIFY messages are sent to the “watchers” regardless of the state of the watcher and regardless if they are in need of the state at the moment. Due to the volume of SIP NOTIFY messages many telecommunications operators are very concerned about the impact on the network and the amount of hardware necessary to support the Presence Server component as well as the wireless bandwidth that might be consumed by these messages. If the volume of notifications could be reduced, the network impact can be alleviated and the amount of Presence Server hardware will be reduced. What is needed is a method to reduce the amount of traffic, particularly traffic that is not of immediate use to the User Equipment target client.

### SUMMARY OF INVENTION

When the client application requiring the presence subscription is not active (as detectable at the UE) the client presence application will send a new message instructing the Presence Server to suspend the messages to this client for the duration of the suspension. When the client becomes active again, the client will send a message instructing the Presence Server to resume sending notifications. Using a modification to the SIP protocol, the client can make a modification to either the SUBSCRIBE or PUBLISH commands to indicate suspension and resumption of notifications. Alternately, using the XCAP protocol, the PUT command can be modified for this purpose.

### LIST OF REFERENCE NUMBERS

101 Client device which is modified to change between accepting notifications and suspending notifications.
102-109 Other Client Devices which publish their status to the presence server.
150 Presence Server modified to receive suspension and resumption messages.

### GLOSSARY

CLIENT Software that accesses a remote service on another computer.
HTTP Hypertext Transfer Protocol
IETF Internet Engineering Task Force
IP Internet Protocol
NOTIFY In the SIP protocol NOTIFY messages are sent to inform subscribers of changes in state to which the subscriber has a subscription.
PUBLISH SIP Command that publishes an event to the server
Presence A presence system as described IETF RFC 3856, allows UEs to subscribe to each other and be notified of changes in state of other users.
RFC IETF Request for Comments Document.
RCS Rich Communications Services is a global initiative to deploy services across telecommunications operators. For consumers, it combines voice and SMS with instant messaging or chat, live video sharing and file transfer across all devices and networks, using mobile devices.
SUBSCRIBE The SUBSCRIBE method is used to request current state and state updates from a remote node.
SIP Session Initiation Protocol is an IETF-defined signaling protocol widely used for controlling communications sessions such as voice and video calls over Internet Protocol.
SMS Short Message Service
UE User Equipment including hardware and software.
URL Uniform Resource Locator is a specific character string that constitutes a reference to a resource.
   XCAP PUT XML Configuration Access Protocol is a set of conventions for mapping XML documents and document components into HTTP URLs including the XCAP PUT command which can be used to move information from a client to a server.
XML Extensible Markup. Language is a markup that defines a set of rules for encoding documents in a format that is both human readable and machine readable.
XCAP XML Configuration Access Protocol.

### BRIEF DESCRIPTION OF DRAWINGS

In FIGS. 1 and 2 it is assumed that presence Client A (101) has previously subscribed for Presence Status updates of Presence Clients B (102) through J (109).

FIG. 1 shows Clients B thru J Publishing a change in their Presence Status (availability, capabilities, and/or social Presence Info) to the Presence Server (150) with Client F (106) having multiple status changes. The Server forwards the status change in SIP Notify messages to Presence Client A for every change.

FIG. 2 shows Presence Client A suspending reception of notifications from the Presence Server. All new published status updates destined for Client A are saved at the Presence Server and queued for aggregated delivery with a single message when Client A Resumes active status updates.

When Client A Resumes with the Presence Serve, the saved status is aggregated and sent to Client A in a single message, thus saving 8 messages sent over the network. If any client 102 through 109 (such as client F (106)) published multiple status updates while client 101 was suspended, then only one aggregated status update for the publishing client is sent to 101.

### DETAILED DESCRIPTION

This is a new method as well as enhancements to industry standard presence clients and presence servers. In one embodiment, when the client application detects or is told by other applications on the UE that the subscriber does not require presence information, the presence client sends a message instructing the Presence Server to suspend the messages to this UE for the duration of the suspension. For example in one embodiment the hardware that contains the presence client may be completely consumed by another task such as GPS navigation or perhaps be completely consumed by display of a video which does not require the presence status of other devices. When presence service becomes required again, the client will send a new message instructing the Presence Server to resume sending presence notifications. The client maintains it's presence relationship during the suspension, but isn't in the mode where it needs the status updates. Immediately following the suspension, multiple notifications (including multiple notifications originating from a single client) are aggregated into a fewer number of notification message. In the preferred embodiment it will be a single notification message

The best known mode of this invention uses a modification to the SIP protocol for notification of suspension and resumption though a second embodiment uses a modification to the XML Configuration Access Protocol (XCAP) for notification of suspension and resumptions.

When a client, such as an RCS client application which may include presence information, subscribes to a presence service and then becomes not active using this innovation, the client will send a suspend message, such as, for example a SUBSCRIBE message with a proprietary tag (e.g. “Event: presence; state=suspend”) instructing the Presence Server to stop the many additional commands being sent to the client. These additional commands are typically SIP NOTIFY commands. When the client, such as the RCS client becomes active again, the RCS client will send another message, in one embodiment a SUBSCRIBE message with a proprietary tag (e.g. “Event: presence; state=resume”), instructing the Presence Server to resume receiving SIP NOTIFYs. In FIG. 2, using this method, the 9 NOTIFY messages from clients B (102) through J (109) are not delivered to Client A (101) when Client A determines the presence is not being actively used This may occur, for example when the RCS suite is a background task for the user equipment (UE). When the UE determines that the presence needs to be activated again, a special resumption message is sent and the queued notifications (in the FIG. 2 case, 9 notifications are received from 8 other clients) are then replaced by a single aggregate notification which is immediately sent to the client, with the end result that the traffic in the telecommunication carriers network is reduced. Since there may be multiple status updates received while the client has suspended its presence, they can be effectively aggregated and immediately sent when a client has requested presence to resume without waiting an interval to see if there are additional status. This method as well as changes to client and server represents a addition to the known RCS standards and allows for the network to accommodate more UE's at a lower level of traffic without noticeable reduction in service. Those with skill in the art will recognize that the SIP PUBLISH Command or, using a different protocol, the XCAP PUT command can also be modified to support this suspension or resumption of notifications from the presence server.

What we claim is:

1) A method to reduce traffic to and from a presence server comprising:
a) a presence client determining when presence information is not actively being used;
b) the presence client requesting the suspension of notifications from a presence server;
c) the presence server suspending notifications to the presence client;
d) the presence server queuing notifications to the suspended client;
e) the presence client requesting the resumption of notifications from the presence server;
f) The presence server sending all notifications queued during the suspension to the client in a fewer number of aggregated notifications;
g) The presence server resuming the immediate sending of new notifications to the client.

2) The method of claim 1 comprising the presence client requesting suspension of notifications using a modified SIP SUBSCRIBE command.

3) The method of claim 1 comprising the presence client requesting suspension of notifications using a modified SIP PUBLISH command.

4) The method of claim 1 comprising the presence client requesting suspension of notifications using a modified XCAP PUT command.

5) A presence server comprising receipt of a message from a client to suspend notifications.

6) The presence server of claim 5 where the message to indicate suspension comprises using a modified SIP SUBSCRIBE command.

7) The presence server of claim 5 where the message to indicate suspension of messages comprises using a modified SIP PUBLISH command.

8) The presence server of claim 5 where the message to indicate suspension of notifications comprises using a modified XCAP PUT command.

9) The presence server of claim 5 which comprises queuing notification messages to the presence client after receiving a message to suspend.

10) The presence server of claim 5 that comprises receiving a message from the presence client to resume presence notifications which have been temporarily suspended.

11) The presence server of claim 5 that comprises sending any notifications queued on the server during the suspension to the presence client aggregated into a reduced number of notification messages to the client.

12) A presence client that comprises detecting when presence information is not needed and notifying a presence server to temporarily suspend notifications.

13) The client of claim 12 where the message to the presence server to suspend notifications comprises using a modified SIP SUBSCRIBE message.

14) The client of claim 12 where the message to the presence server to suspend notifications comprises using a modified SIP PUBLISH message.

15) The client of claim 12 where the message to the presence server to suspend notifications comprises using a modified XCAP PUT message.

16) A presence client which comprises detecting when presence information is needed and sending a message to the presence server to resume notifications.

17) The client of claim 16 where the message to the presence server to resume notifications comprises using a modified SIP SUBSCRIBE message.

18) The client of claim 16 where the message to the presence server to resume notifications comprises using a modified SIP PUBLISH message.

19) The client of claim 16 where the message to the presence server to resume notifications comprises using a modified XCAP PUT message.
